(19) United States
(12) Patent Application Publication
(10) Pub. No.: US 2022/0134778 A1
(43) Pub. Date: May 5, 2022

(54) IMAGE FORMING APPARATUS

(71) Applicant: Isao MATSUSHIMA, Ibaraki (JP)

(72) Inventor: Isao MATSUSHIMA, Ibaraki (JP)

(73) Assignee: Ricoh Company, Ltd., Tokyo (JP)

(21) Appl. No.: 17/497,259

(22) Filed: Oct. 8, 2021

(30) Foreign Application Priority Data
Oct. 29, 2020 (JP) 2020-181642

(51) Int. Cl. B41J 11/00; B05C 1/08; B41M 5/00; B41J 2/01

(52) U.S. Cl. CPC B41J 11/0015; B05C 1/083; B41J 2/01; B41J 11/006; B41M 5/0017

(57) ABSTRACT

An image forming apparatus includes a recording medium stacker, an application unit, an image forming unit and a sheet reverse passage. The recording medium stacker is configured to stack a recording medium. The application unit is configured to apply a treatment liquid to the recording medium. The image forming unit is disposed downstream from the application unit in a conveyance direction of the recording medium. The image forming unit being configured to form an image on the recording medium. The sheet reverse passage is configured to reverse the recording medium after the recording medium passes through the image forming unit to re-convey the recording medium to the application unit.

### CROSS-REFERENCE TO RELATED APPLICATIONS

This patent application is based on and claims priority pursuant to 35 U.S.C. § 119(a) to Japanese Patent Application No. 2020-181642, filed on Oct. 29, 2020, in the Japan Patent Office, the entire disclosure of which is incorporated by reference herein.

### BACKGROUND

### Technical Field

Embodiments of the present disclosure relate to an image forming apparatus.

### Related Art

Image forming apparatuses are known to include a recording medium stacker on which recording media are stacked, an application unit to apply a treatment liquid to the recording media, and an image forming unit that is disposed downstream from the application unit in a sheet conveyance direction and forms images on the recording media.

For example, a known image forming apparatus includes an applied-sheet reverse passage for reversing a recording medium having a treatment liquid applied on one side and conveying the recording medium to the application unit again, and a sheet reverse passage for reversing the recording medium having the image formed on the one side and conveying the recording medium to the image forming unit again. When images are formed on both sides of the recording medium, the treatment liquid is applied to both sides of the recording medium, and then respective images are formed on both sides of the recording medium.

### SUMMARY

Embodiments of the present disclosure described herein provide a novel image forming apparatus including a recording medium stacker, an application unit, an image forming unit and a sheet reverse passage. The recording medium stacker is configured to stack a recording medium. The application unit is configured to apply a treatment liquid to the recording medium. The image forming unit is disposed downstream from the application unit in a conveyance direction of the recording medium. The image forming unit is configured to form an image on the recording medium. The sheet reverse passage is configured to reverse the recording medium after the recording medium passes through the image forming unit to re-convey the recording medium to the application unit.

Further, embodiments of the present disclosure described herein provide an image forming apparatus including a first sheet conveyance passage and a second sheet conveyance passage. The first sheet conveyance passage is configured to convey the recording medium fed from the recording medium stacker to the application unit. The second sheet conveyance passage is configured to convey the recording medium without passing through the application unit. The sheet reverse passage is configured to merge with another conveyance passage upstream, in the conveyance direction of the recording medium, from a portion in which the sheet reverse passage branches into the first sheet conveyance passage and the second sheet conveyance passage.

Further, embodiments of the present disclosure described herein provide an image forming apparatus including a plurality of recording medium stackers. The plurality of recording medium stackers includes the recording medium stacker. The plurality of recording medium stackers is configured to stack the recording medium. The sheet reverse passage is configured to merge with another conveyance passage downstream, in the conveyance direction of the recording medium, from a merging portion in which the recording medium fed from the recording medium stacker meets said another conveyance passage.

Further, embodiments of the present disclosure described herein provide an image forming apparatus including a plurality of recording medium stackers and a plurality of sheet feeding passages. The plurality of recording medium stackers includes the recording medium stacker. The plurality of recording medium stackers is configured to stack the recording medium. The plurality of sheet feeding passages is disposed corresponding to the plurality of recording medium stackers. The sheet reverse passage is configured to merge with one of the plurality of sheet feeding passages.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram illustrating a schematic configuration of an image forming system according to an embodiment of the present disclosure;

FIG. 2 is a diagram illustrating a schematic configuration of an application unit;

FIG. 3 is a schematic enlarged diagram of a part around an area A1 in FIG. 1;

FIG. 4 is a diagram illustrating an example of a general image forming system;

FIG. 5 is a schematic enlarged diagram illustrating a part around a merging conveyance passage in a first variation;

FIG. 6 is a diagram illustrating a schematic configuration of an image forming system according to a second variation; and

FIG. 7 is a diagram illustrating an example in which the sheet return passage of the sheet reverse passage is merged at a position upstream from the position of the application unit in the sheet conveyance direction in the sheet conveyance passage.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Referring now to the drawings, embodiments of the present disclosure are described below. As used herein, the singular forms “a,” “an,” and “the” are intended to include the plural forms as well, unless the context clearly indicates otherwise.

Descriptions are given of an example applicable to embodiments of the present disclosure.

Note that the terms “image formation”, “recording”, “printing”, “image printing”, and “molding” used in the present disclosure may be used synonymously with each other.

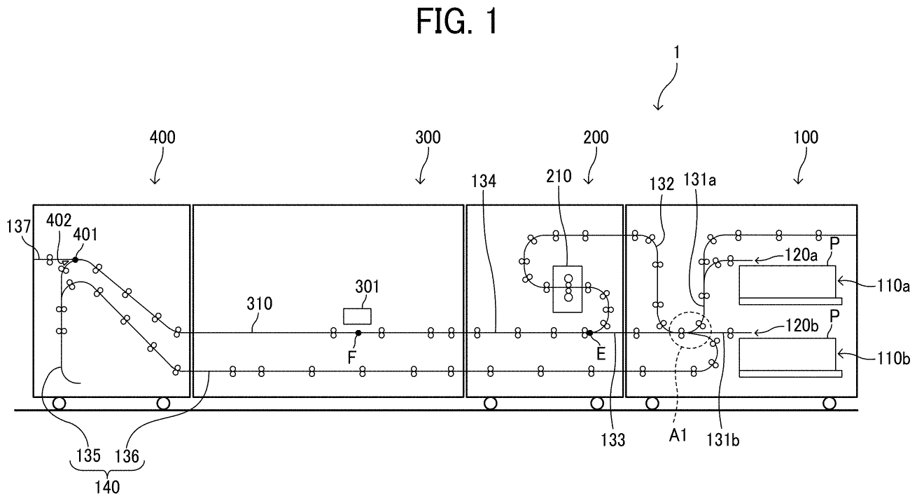

FIG. 1 is a schematic diagram illustrating a schematic configuration of an image forming system 1 according to the present embodiment.

The image forming system 1 according to the present embodiment mainly includes a sheet feeding device 100, an application device 200, an image forming device 300, and a sheet ejection device 400. In the image forming system 1, after the application device 200 applies a treatment liquid to a sheet P fed from the sheet feeding device 100, the image forming device 300 forms an image on the sheet P with ink that is a liquid for image formation. Then, the sheet P is ejected by the sheet ejection device 400.

### Sheet Feeding Device

The sheet feeding device 100 includes an upper sheet feed tray 110a and a lower sheet feed tray 110b, each functioning as a recording medium stacker on which a plurality of sheets P are stacked. Further, the sheet feeding device 100 includes an upper sheet feeding unit 120a and a lower sheet feeding unit 120b. The upper sheet feeding unit 120a separates and feeds the sheets stacked on the upper sheet feed tray 110a one by one. The lower sheet feeding unit 120b separates and feeds the sheets stacked on the lower sheet feed tray 110b one by one.

### Application Device

The application device 200 is disposed between the sheet feeding device 100 and the image forming device 300. The application device 200 includes an application unit 210 as a liquid applier that applies the treatment liquid to the sheet P.

### Image Forming Device

The image forming device 300 is disposed between the application device 200 and the sheet ejection device 400. The image forming device 300 includes an inkjet recording unit 301 that is an image forming unit and a liquid discharge unit. The image forming device 300 is a “liquid discharging device” that discharges liquid toward the sheet P.

The inkjet recording unit 301 forms an image by discharging inks of four colors of C (cyan), M (magenta), Y (yellow), and K (black). The inkjet recording unit 301 includes individual liquid discharge heads for the respective inks.

The “liquid discharge unit” such as the inkjet recording unit 301 is a unit in which functional components and mechanisms are integrated with the liquid discharge head. The liquid discharge unit includes an assembly of components related to liquid discharge. For example, the “liquid discharge unit” may include a combination of the liquid discharge head and at least one of a head tank, a carriage, a supply mechanism, a maintenance-recovery mechanism, a main scanning moving mechanism, and a liquid circulator.

In the integrated unit, for example, the liquid discharge head and at least one of a functional components and a mechanism may be fixed to each other by fastening, bonding, or engaging, or one of the liquid discharge head and at least one of a functional part and a mechanism may be movably held to one to another. The liquid discharge head may be detachably attached to the functional component and the mechanism.

For example, the liquid discharge head and the head tank may be integrated into a single unit as the liquid discharge unit. Further, the liquid discharge head and the head tank may be integrated into a single unit by connecting with a tube each other. Further, a unit including a filter may be added between the head tank of the liquid discharge unit and the liquid discharge head.

Further, the liquid discharge unit may include the liquid discharge head and the carriage that are integrated into a single unit.

Further, the liquid discharge head and the main scanning moving mechanism may be integrated into a single unit as the liquid discharge unit, and the liquid discharge head may be movably held by a guide member including a part of the main scanning moving mechanism. Further, the liquid discharge head, the carriage, and the main scanning moving mechanism may be integrated into a single unit.

Further, the liquid discharge head, the carriage, and the maintenance-recovery mechanism may be integrated into a single unit as the liquid discharge unit, and a carriage attached to the liquid discharge head may be fixed to a cap of a part of a maintenance-recovery mechanism.

Further, the liquid discharge head and the supply mechanism may be integrated into a single unit by connecting a tube to the liquid discharge head attaching the head tank or flow path components. The liquid in the liquid storage source is supplied to the liquid discharge head via the tube.

The main scanning movement mechanism includes a single guide member. The supply mechanism includes a single tube or a single loading unit.

The “liquid discharge device” such as the image forming device 300 includes a device that includes the liquid discharge head or the liquid discharge unit and that drives the liquid discharge head to discharge liquid.

The “liquid discharge device” may include at least one of devices for feeding, conveying, and ejecting a material to which liquid is adherable. The liquid discharge device may further include at least one of a pre-processing device and a post-processing device. The “liquid discharge device” is not limited to a device to discharge liquid to visualize meaningful images, such as letters or figures. For example, the “liquid discharge device” may be a device that forms meaningless images such as meaningless patterns.

The “liquid discharge device” may be a device that relatively moves a liquid discharge head and a material to which liquid is adherable. However, the “liquid discharge device” is not limited to such a device. For example, the device may include a printing device including a serial head device that moves the liquid discharge head or a line head device that does not move the liquid discharge head.

The discharging operation of each liquid discharge head of the inkjet recording unit 301 is controlled by a drive signal corresponding to image information. When the sheet P as the “material to which the liquid adheres” passes through the region facing the inkjet recording unit 301, each color ink is discharged from each liquid discharge head to form an image corresponding to the image information.

The “material to which the liquid adheres” denotes, for example, a material or a medium onto which liquid is adhered at least temporarily, a material or a medium onto which liquid is adhered and fixed, or a material or a medium onto which liquid is adhered and permeated. Specific examples of the “material to which the liquid adheres” include, but are not limited to, recording media and electronic component. The recording media includes a paper sheet, a recording paper, a recording sheet of paper, a film, and a cloth. The electronic component includes an electronic substrate and piezoelectric element. The “material to which the liquid adheres” includes any material onto which liquid adheres unless particularly limited.

The material of the above-described “material to which the liquid is adherable” is made of any material provided that liquid is adherable at least temporarily to the material. For example, the “material to which liquid is adherable” may include any materials on which liquid adheres even temporarily, such as paper, threads, fibers, fabric, leather, metal, plastic, glass, wood, and ceramic.

### Sheet Ejection Device

The sheet ejection device 400 includes a sheet ejection branching point 401 at which a passage branches into a sheet ejection passage 137 and a sheet reverse passage 140. When the sheet ejection device 400 receives the sheet P on which an image is formed from the image forming device 300 in a case in which images are formed on both sides of the sheet P, the sheet P is guided to the sheet reverse passage 140 by the switching claw 402 disposed at or near the sheet ejection branching point 401. On the other hand, when the sheet P is ejected, the sheet P is conveyed to the sheet ejection passage 137 by the switching claw 402 to eject the sheet P.

The imaging forming system 1 includes an upper sheet feeding passage 131a through which the sheet P fed from the upper sheet feed tray 110a is conveyed, and a lower sheet feeding passage 131b through which the sheet P fed from the lower sheet feed tray 110b is conveyed. Further, the image forming system 1 includes an application sheet passage 132 that conveys the sheet P to the application unit 210 and a non-application sheet passage 133 that does not convey the sheet P to the application unit 210. Further, the image forming system 1 includes a relay conveyance passage 134 in which the application sheet passage 132 and the non-application sheet passage 133 merge with each other to convey the sheet toward the inkjet recording unit 301. Further, the image forming system 1 includes a printed sheet conveyance passage 310 that conveys the sheet after image formation, to the sheet ejection branching point 401. Further, the image forming system 1 includes the sheet ejection passage 137 and the sheet reverse passage 140. The sheet reverse passage 140 includes a switchback passage 135 and a sheet return passage 136.

The application sheet passage 132 is a conveyance passage ranging from an application branching portion C (refer to FIG. 3) branching into the application sheet passage 132 and the non-application sheet passage 133, to an application merging portion E where the non-application sheet passage 133 merges via the application unit 210. The non-application sheet passage 133 is a conveyance passage ranging from the application branching portion C to the application merging portion E without passing through the application unit 210. The application sheet passage 132 and the non-application sheet passage 133 lie across the sheet feeding device 100 and the application device 200.

The relay conveyance passage 134 is a conveyance passage ranging from the application merging portion E to an image forming portion (ink discharge portion) F where an image is formed on the sheet by the inkjet recording unit 301. The relay conveyance passage 134 lies across the application device 200 and the image forming device 300. The printed sheet conveyance passage 310 is a conveyance passage ranging from the image forming portion F to the sheet ejection branching point 401. The printed sheet conveyance passage 310 lies across the image forming device 300 and the sheet ejection device 400. The sheet return passage 136 of the sheet reverse passage 140 is a conveyance passage that branches off from the switchback passage 135 and reaches a re-entry conveyance merging portion B that merges with a merging conveyance passage 138 (refer to FIG. 3). The description of the merging conveyance passage 138 is deferred. The sheet return passage 136 lies across the sheet ejection device 400, the image forming device 300, the application device 200, and the sheet feeding device 100.

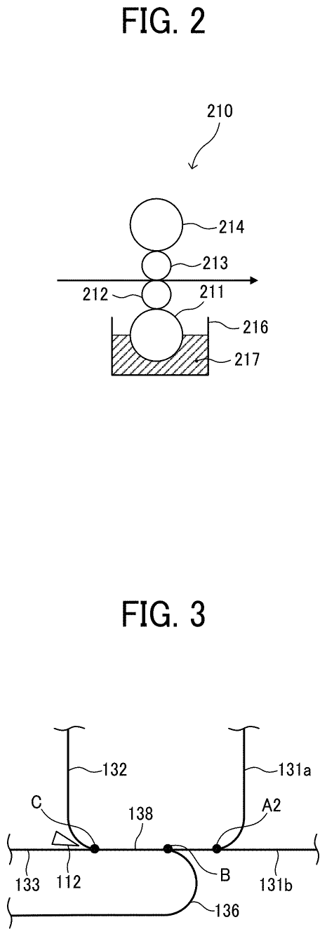

FIG. 2 is a schematic diagram illustrating a schematic configuration of the application unit 210.

The application unit 210 includes a supply pan 216, a squeeze roller 211, an application roller 212, a pressure roller 213, and a pressing roller 214. The supply pan 216 stores treatment liquid 217. A part of the squeeze roller 211 is immersed in the treatment liquid 217 in the supply pan 216 to draw up the treatment liquid 217 in the supply pan 216. The application roller 212 receives the treatment liquid from the squeeze roller 211 to apply the treatment liquid to the sheet P. The pressure roller 213 contacts the application roller 212 to form an application nip with the application roller 212. The pressing roller 214 presses the pressure roller 213 to prevent the pressure roller 213 from bending in the longitudinal direction.

Examples of the treatment liquid 217 include a modifying material that modifies the surface of the sheet P by being applied to the surface of the sheet P. Examples of the modifying material include a material that modify the surface of the sheet by preliminary applying the treatment liquid uniformly on the sheet, so as to promptly penetrate the moisture of the ink into the sheet, increase the viscosity of the color component, accelerate the drying, and prevent bleeding (or feathering) and bleed-through. By applying such a modifying material as the treatment liquid, productivity (i.e., the number of output images per unit time) of image formation is increased.

Compositionally, the treatment liquid 217 is preferably a solution containing, for example, a surfactant, celluloses to facilitate penetration of moisture, and a base such as talc fine powder. The treatment liquid 217 may further contain fine particles. Examples of the surfactant include an anionic surfactant, a cationic surfactant, a nonionic surfactant, or a mixture of two or more of the surfactants. Examples of the celluloses include a hydroxypropyl cellulose.

The treatment liquid 217 drawn up by the squeeze roller 211 is delivered to the application roller 212. Then, the treatment liquid 217 is applied to one side of the sheet P conveyed to the application nip by the application roller 212.

As illustrated in FIG. 1, the application sheet passage 132 in the application device 200 has an S-shape, and the application unit 210 is disposed on the conveyance passage in which the upper and lower surfaces of the sheet on the application sheet passage 132 are reversed. The first face of the sheet, which is the upper surface in the sheet feed tray, is conveyed to the application unit 210 as the lower surface. As a result, the application roller 212 is disposed below the first face of the sheet, therefore the supply pan 216 is disposed below the application roller 212 so as to prevent the treatment liquid from dripping from the supply pan 216 onto the sheet or from the application roller 212 onto the sheet. Then, after passing through the application unit 210, the upper and lower surfaces of the sheet are reversed again, and the sheet is conveyed to the relay conveyance passage 134 with the first face with the treatment liquid being the upper surface again. As a result, the inkjet recording unit 301 is disposed on the upper side of the first surface of the sheet, and the image is formed by discharging the ink onto the first face of the sheet with the first face up.

FIG. 3 is a schematic enlarged diagram of a part around an area A1 in FIG. 1.

As illustrated in FIG. 3, the sheet feeding device 100 has the merging conveyance passage 138. The merging conveyance passage 138 is a conveyance passage ranging from a feeding merging portion A2 to the application branching portion C. The feeding merging portion A2 is a portion in which the upper sheet feeding passage 131a and the lower sheet feeding passage 131b merge with each other. The application branching portion C is a portion in which the merging conveyance passage 138 branches into the application sheet passage 132 and the non-application sheet passage 133. The sheet return passage 136 of the sheet reverse passage 140 merges with the merging conveyance passage 138.

In the present embodiment, interleaf conveyance control is performed in the case of forming images on both sides of a predetermined number or more of sheets after the treatment liquid is applied onto both sides of each of the sheets (hereinafter referred to as “duplex printing with liquid application”).

In the interleaf conveyance control, the sheets P are continuously conveyed at a predetermined interval from one of the upper sheet feed tray 110a or the lower sheet feed tray 110b. At this time, the switching claw 112 disposed at the application branching portion C takes a posture of guiding the sheets to the application sheet passage 132, and the fed sheets are conveyed to the application sheet passage 132 after passing through the merging conveyance passage 138. Then, the treatment liquid is sequentially applied to the first face of each of the sheets by the application unit 210, and then the sheets are sequentially conveyed to the relay conveyance passage 134. After an image is sequentially formed on the first face of each of the sheets by the inkjet recording unit 301, the sheet is sequentially conveyed to the sheet reverse passage 140. Then, the sheets are switched back in the switchback passage 135 and sequentially conveyed to the sheet return passage 136.

When the first sheet of the sheets reaches a position before the re-entry conveyance merging portion B in which the first sheet meets with the merging conveyance passage 138 of the sheet return passage 136, the conveyance of the sheets is temporarily stopped. When restarting the conveyance of the sheets, the conveyance of the sheets from the upper sheet feeding passage 131a or the lower sheet feeding passage 131b to the merging conveyance passage 138 is temporarily stopped, and the first sheet in the sheet return passage 136 is conveyed to the merging conveyance passage 138. Thereafter, the conveyance of the sheets from the upper sheet feeding passage 131a or the lower sheet feeding passage 131b to the merging conveyance passage 138 and the conveyance of the sheets from the sheet return passage 136 to the merging conveyance passage 138 are alternately performed. As a result, a sheet having an image formed on one side (i.e., the first face) and a sheet having no image formed on both sides are alternately conveyed to the application sheet passage 132, and are applied with the treatment liquid by the application unit 210. Thereafter, the sheets are conveyed to the relay conveyance passage 134, and an image is formed on each of the sheets by the inkjet recording unit 301. Then, the switching claw 402 is switched between the intervals of the sheets. The sheets each having images formed on both sides are conveyed to the sheet ejection passage 137, and the sheets each having an image formed on one side alone are conveyed to the sheet reverse passage 140.

Note that, when images are formed on both sides of a sheet without applying a treatment liquid to the sheet (hereinafter referred to as “duplex printing without liquid application”), the sheet is conveyed by the same interleaf conveyance control as described above, except that the sheet is conveyed to the relay conveyance passage 134 via the non-application sheet passage 133.

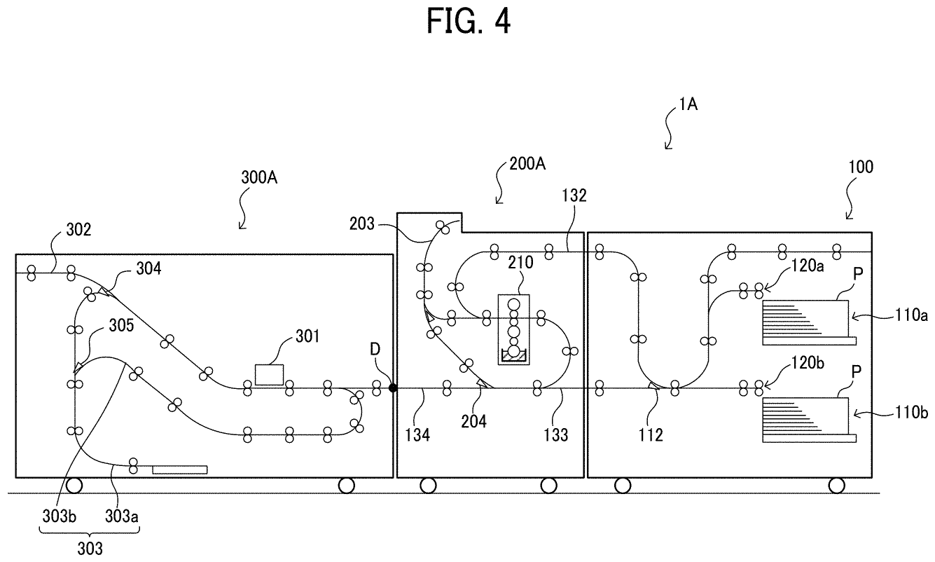

FIG. 4 is a diagram illustrating an example of a general image forming system 1A.

In the general image forming system 1A illustrated in FIG. 4, an application device 200A has a sheet reverse passage 203. A sheet return passage 303a of a sheet reverse passage 303 merge with the conveyance passage from a receiving portion D that receives the sheet from the application device 200A in the image forming system 1A to the inkjet recording unit 301.

In the case of duplex printing with liquid application, the treatment liquid is applied to the first face of the sheet by the application unit 210, and then the sheet is conveyed to the sheet reverse passage 203. Then, the sheet is switched back in the sheet reverse passage 203 and is conveyed again to the application unit 210, and the treatment liquid is applied on the second face of the sheet. Then, after an image is formed on the second face of the sheet, the sheet is conveyed to the sheet reverse passage 303 and conveyed again to the inkjet recording unit 301, and an image is formed on the first face of the sheet.

As described above, in the general image forming system 1A, after the treatment liquid is applied onto both sides of the sheet by the application device 200A, images are formed on both sides of the sheet by an image forming device 300A. Therefore, the time from when the treatment liquid is applied to the first face of the sheet to when an image is formed on the first face of the sheet is different from the time from when the treatment liquid is applied to the second face of the sheet to when an image is formed on the second face of the sheet. As a result, the dry state of the treatment liquid applied to the first face when an image is formed on the first face of the sheet differs from the dry state of the treatment liquid applied to the second face when an image is formed on the second face of the sheet. As a result, the effect of the treatment liquid may be different between the first face and the second face of the sheet, and the image quality may be different between the first face and the second face of the sheet.

On the other hand, in the image forming system 1 of the present embodiment, the sheet return passage 136 of the sheet reverse passage 140 is merged with the merging conveyance passage 138, and duplex printing with liquid application is performed as follows. That is, after the treatment liquid is applied to the first face of the sheet, an image is formed on the first face of the sheet. Then, the sheet is conveyed sequentially to the sheet reverse passage 140, the merging conveyance passage 138 and the application sheet passage 132. Thereafter, the treatment liquid is applied to the second face of the sheet, and then an image is formed on the second face of the sheet.

The conveyance of the sheet from when the treatment liquid is applied to the first face of the sheet to when an image is formed on the first face of the sheet shares the same sheet conveyance passage with the conveyance of the sheet from when the treatment liquid is applied to the second face of the sheet to when an image is formed on the second face of the sheet. Further, the sheet conveying speed is substantially the same between these conveyances of the sheet. Therefore, the time from when the treatment liquid is applied to the first face of the sheet to when an image is formed on the first face of the sheet is substantially the same as the time from when the treatment liquid is applied to the second face of the sheet to when an image is formed on the second face of the sheet. As a result, when the inkjet recording unit 301 forms an image on a sheet, the dry state of the treatment liquid is substantially the same between the first face and the second face of the sheet. Therefore, the effect of the treatment liquid is substantially the same between the first face and the second face of the sheet. Therefore, the image quality of the first face of the sheet is substantially the same as the image quality of the second face of the sheet.

Hereinafter, a description is given of variations of the image forming system 1 according to the present embodiment.

### First Variation

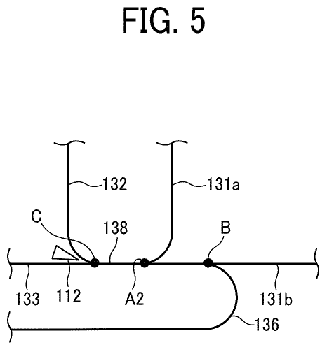

FIG. 5 is a schematic enlarged diagram illustrating a part around the merging conveyance passage 138 in a first variation.

In the first variation, the sheet return passage 136 merges with the lower sheet feeding passage 131b. Similar to the configuration of the above-described embodiment, with the configuration of the first variation, an image is formed on the first face of the sheet after applying the treatment liquid to the first face of the sheet. The sheet is conveyed to the sheet reverse passage 140, the merging conveyance passage 138, and the application sheet passage 132 sequentially. Then, an image is formed on the second face after applying the treatment liquid to the second face of the sheet.

In the configuration of the first variation, the merging conveyance passage 138 is shortened as much as possible. Therefore, the entire length of the image forming system 1 is shortened.

Further, when the interleaf conveyance control is performed in the configuration of the first variation, the sheet having the image on the first face that is conveyed from the sheet return passage 136 may be temporarily stopped at a position before the feeding merging portion A2 at which the upper sheet feeding passage 131a and the lower sheet feeding passage 131b merge with each other.

### Second Variation

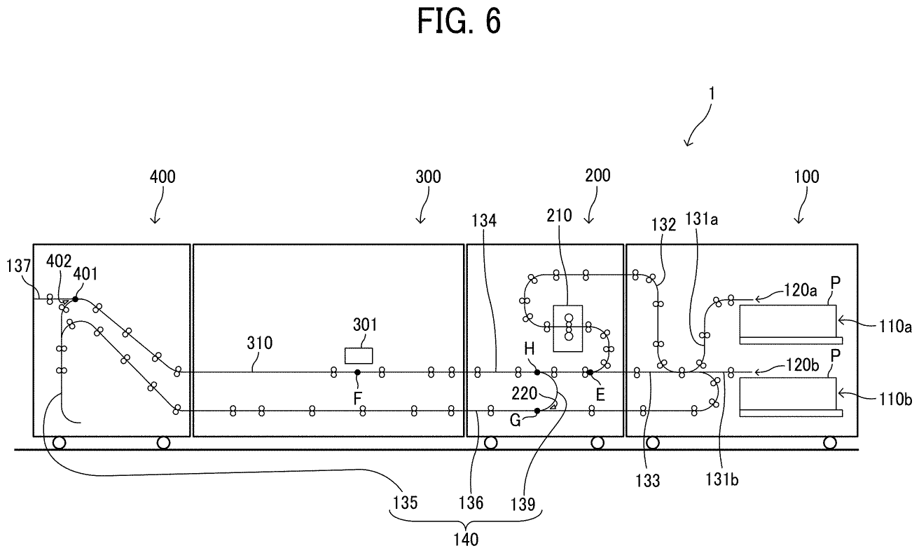

FIG. 6 is a diagram illustrating a schematic configuration of the image forming system according to a second variation.

In the second variation, a branch conveyance passage 139 that merges with the relay conveyance passage 134 is provided in the sheet reverse passage 140. The branch conveyance passage 139 is branched in the middle of the sheet return passage 136 that merges with the lower sheet feeding passage 131b or the merging conveyance passage 138, and merges with the relay conveyance passage 134. In the configuration of the image forming system 1 illustrated in FIG. 6, the branch conveyance passage 139 merges with the relay conveyance passage 134 provided in the application device 200 but may merge with the relay conveyance passage 134 provided in the image forming device 300.

In the case of duplex printing without liquid application, a switching claw 220 disposed at a branch portion G, at which the branch conveyance passage 139 branches off from the sheet return passage 136, takes a posture for guiding a sheet to the branch conveyance passage 139, and re-conveys the sheet having an image formed on the first face to a relay conveyance passage 134. After an image is formed on the second face of the sheet by the inkjet recording unit 301, the sheet is ejected to the outside of the image forming system 1.

In the interleaf conveyance control for the duplex printing without liquid application, the sheet having the image formed on the first face is temporarily stopped at a position before the merging portion H of the branch conveyance passage 139 with the relay conveyance passage 134. Then, the sheet having no image formed on both sides, which is conveyed to the relay conveyance passage 134 via the non-application sheet passage 133, and the sheet having an image formed on the first face are alternately conveyed toward the inkjet recording unit 301.

When conveying the sheet having the image formed on the first face to the inkjet recording unit 301 in the duplex printing without liquid application, the conveyance passage in the configuration of the second variation is shorter than the conveyance passage in a configuration without the branch conveyance passage 139. As a result, a reduction in productivity is restrained when performing the during duplex printing without liquid application. In addition, the configuration of the second variation contributes to a reduction in the number of sheets to be used to perform the interleaf conveyance control of the duplex printing without liquid application.

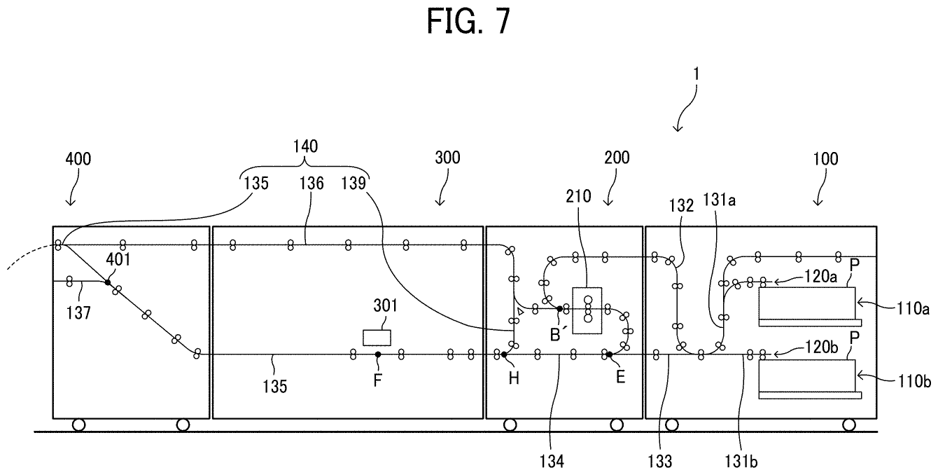

Further, FIG. 7 is a diagram illustrating another example of the image forming system 1 in which the sheet return passage of the sheet reverse passage is merged at a position upstream from the position of the application unit in the sheet conveyance direction in the sheet conveyance passage. As illustrated in FIG. 7, the sheet return passage 136 of the sheet reverse passage 140 may be merged with the application sheet passage 132 on the upstream side of the application unit 210 in the conveyance direction. Similar to the above-described embodiment and variations, the configuration of the image forming system 1 illustrated in FIG. 7, the sheet having an image formed on the first face is conveyed to the application unit 210, the treatment liquid is applied on the second face of the sheet, and then an image is formed on the second face of the sheet. In addition, this configuration shortens the conveyance passage to re-convey the sheet having an image formed on the first face to the inkjet recording unit 301 in the duplex printing with liquid application. As a result, the configuration in FIG. 7 contributes to restrain a reduction in productivity when images are formed on both sides of the sheet by applying the treatment liquid. In addition, the number of sheets to be used to perform the interleaf conveyance control is reduced.

In the configuration illustrated in FIG. 7, a branch conveyance passage 139 is provided, as in the second variation. Therefore, in the case of duplex printing without liquid application, the sheet having an image formed on the first face is re-conveyed to the relay conveyance passage 134, and an image is formed on the second face of the sheet by the inkjet recording unit 301.

Aspects of the present disclosure provide respective effects as follows.

### Aspect 1

An image forming apparatus such as the image forming system 1 includes a recording medium stacker, an application unit, an image forming unit, and a sheet reverse passage. The recording medium stacker such as an upper sheet feed tray 110a and a lower sheet feed tray 110b is configured to stack a recording media such as the sheet P. The application unit such as an application unit 210 is configured to apply a treatment liquid to the recording medium. The image forming unit such as the inkjet recording unit 301 is disposed downstream from the application unit in a conveyance direction of the recording medium and configured to form an image on the recording media. The sheet reverse passage such as a sheet reverse passage 140 is configured to reverse the recording medium after the recording medium passes through the image forming unit to re-convey the recording medium to the application unit.

According to a known image forming apparatus, images are formed on both sides of the recording medium after the treatment liquid is applied to both sides of the recording medium. Therefore, the time from the application of the treatment liquid to the formation of an image differs between the first face and the second face of the recording medium. As a result, the dry state of the treatment liquid on the first face of the recording medium when an image is formed on the first face of the recording medium differs from the dry state of the treatment liquid on the second face of the recording medium when an image is formed on the second face of the recording medium. Accordingly, the effects of the treatment liquid on the first face and the effects of the treatment liquid on the second face are different from each other.

On the other hand, in Aspect 1, the image forming apparatus includes the sheet reverse passage to reverse the recording medium after passing through the image forming unit, and then re-convey the recording medium to the application unit. Thus, after the treatment liquid is applied to the first face of the recording medium, an image is formed on the first face. Then, the recording medium is conveyed again to the application unit by the sheet reverse passage, and an image is formed on the second face after the treatment liquid is applied on the second face of the recording medium. Thus, the time from the application of the treatment liquid to the first face to the formation of an image on the first face is substantially the same as the time from the application of the treatment liquid to the second face to the formation of an image on the second face. As a result, the drying state of the treatment liquid at the time of forming an image is substantially the same between the first face and the second face of the sheet, and the effect of the treatment liquid is substantially the same between the first face and the second face of the sheet.

### Aspect 2

In Aspect 1, the image forming apparatus includes an application sheet passage 132, and a non-application sheet passage 133. The application sheet passage 132 is configured to conveys the recording medium fed from the recording medium stacker such as the upper sheet feed tray 110a and the lower sheet feed tray 110b to the application unit such as the application unit 210. The non-application sheet passage 133 is configured to convey the recording medium without passing through the application unit. The sheet reverse passage 140 is configured to merge with another conveyance passage upstream, in the conveyance direction of the recording medium, from a portion such as an application branching portion C at which the sheet reverse passage branches into the application sheet passage 132 and the non-application sheet passage 133.

According to this configuration, as described in the present embodiment, when the treatment liquid is applied to the recording medium such as the sheet P to form the images on both sides, the recording medium having the image formed on the first face is conveyed to the application sheet passage 132. Accordingly, after the treatment liquid is applied to the second face of the recording medium, an image is formed on the second face of the recording medium. On the other hand, when images are formed on both sides of the recording medium without applying the treatment liquid to the recording medium, the recording medium having an image formed on the first face is conveyed to the non-application sheet passage 133. Accordingly, the recording medium is conveyed to an image forming unit such as the inkjet recording unit 301 without passing through an application unit such as the application unit 210. As a result, the configuration of Aspect 2 enhances the productivity when images are formed on both sides of the recording medium without applying the treatment liquid to the recording medium.

### Aspect 3

In Aspect 1 or 2, the image forming apparatus includes a plurality of the recording medium stackers such as the sheet feeding tray including the recording medium stacker. The plurality of recording medium stackers is configured to stack the recording medium. The sheet reverse passage is configured to merge with another conveyance passage downstream, in the conveyance direction of the recording medium, from a merging portion such as a feeding merging portion A in which the recording medium fed from the recording medium stacker meets said another conveyance passage.

According to this configuration, the sheet reverse passage is shortened as compared with the case where the sheet reverse passage 140 is merged with any one of a plurality of sheet feeding passages 131, which are the upper sheet feeding passages 131a and the lower sheet feeding passages 131b, disposed corresponding to the respective the recording medium stackers such as the sheet feeding tray.

### Aspect 4

In Aspect 1 or 2, the image forming apparatus includes a plurality of the recording medium stackers such as the sheet feeding tray, and a plurality of sheet feeding passages such as a upper sheet feeding passage 131a and a lower sheet feeding passage 131b. The plurality of recording medium stackers include the recording medium stacker. The plurality of recording medium stackers is configured to stack the recording medium. The plurality of sheet feeding passages are disposed corresponding to the plurality of recording medium stackers. The sheet reverse passage is configured to merge with one of the plurality of sheet feeding passages.

According to this configuration, as described in the first variation, the entire length of the image forming system is shortened.

### Aspect 5

In any one of Aspects 1 to 4, the sheet reverse passage 140 includes a branch passage such as a branch conveyance passage 139. The branch passage is configured to merge with a conveyance passage (the relay conveyance passage 134 in the present embodiment) between the application unit such as the application unit 210 and the image forming unit such as the inkjet recording unit 301.

According to this configuration, as described in the second variation, when images are formed on both sides of the recording medium such as the sheet without applying the treatment liquid, the conveyance passage for conveying the sheet having the image formed on the first surface to the image forming unit such as the inkjet recording unit 301 is shortened, compared to a case where the branch conveyance passage 139 is not disposed. As a result, the configuration of Aspect 5 restrains a reduction in productivity when images are formed on both sides of the sheet without applying the treatment liquid.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

What is claimed is:

1. An image forming apparatus comprising:
a recording medium stacker configured to stack a recording medium;
an application unit configured to apply a treatment liquid to the recording medium;
an image forming unit disposed downstream from the application unit in a conveyance direction of the recording medium,
the image forming unit being configured to form an image on the recording medium; and
a sheet reverse passage configured to reverse the recording medium after the recording medium passes through the image forming unit to re-convey the recording medium to the application unit.

2. The image forming apparatus according to claim 1, further comprising:
a first sheet conveyance passage configured to convey the recording medium fed from the recording medium stacker to the application unit; and
a second sheet conveyance passage configured to convey the recording medium without passing through the application unit,
wherein the sheet reverse passage is configured to merge with another conveyance passage upstream, in the conveyance direction of the recording medium, from a portion in which the sheet reverse passage branches into the first sheet conveyance passage and the second sheet conveyance passage.

3. The image forming apparatus according to claim 1, further comprising a plurality of recording medium stackers including the recording medium stacker, the plurality of recording medium stackers being configured to stack the recording medium,
wherein the sheet reverse passage is configured to merge with another conveyance passage downstream, in the conveyance direction of the recording medium, from a merging portion in which the recording medium fed from the recording medium stacker meets said another conveyance passage.

4. The image forming apparatus according to claim 1, further comprising:
a plurality of recording medium stackers including the recording medium stacker, the plurality of recording medium stackers being configured to stack the recording medium; and
a plurality of sheet feeding passages disposed corresponding to the plurality of recording medium stackers,
wherein the sheet reverse passage is configured to merge with one of the plurality of sheet feeding passages.

5. The image forming apparatus according to claim 1,
wherein the sheet reverse passage includes a branch passage configured to merge with a conveyance passage between the application unit and the image forming unit.
